(19) United States
(12) Patent Application Publication
(10) Pub. No.: US 2014/0138569 A1
(43) Pub. Date: May 22, 2014

(54) COMPOSITE PARTICLE, POWDER CORE, MAGNETIC ELEMENT, AND PORTABLE ELECTRONIC DEVICE

(71) Applicant: Seiko Epson Corporation, Tokyo (JP)

(72) Inventors: Isamu OTSUKA, Hachinohe (JP); Yu MAETA, Hachinohe (JP); Toshikuni SATO, Hachinohe (JP)

(21) Appl. No.: 14/083,930

(22) Filed: Nov. 19, 2013

(30) Foreign Application Priority Data
Nov. 20, 2012 (JP) 2012-254452

(51) Int. Cl. H01F 1/01; H01F 27/255

(52) U.S. Cl. CPC H01F 1/01; H01F 27/255
USPC 252/62.54; 252/62.51 R; 252/62.55; 336/233

(57) ABSTRACT

A composite particle includes: a first particle composed of a soft magnetic metallic material; and second particles composed of a soft magnetic metallic material having a different composition from that of the first particle and adhered to the first particle so as to cover the first particle, wherein when the Vickers hardness of the first particle is represented by HV1 and the Vickers hardness of the second particle is represented by HV2, HV1 and HV2 satisfy the following relationships: 250≦HV1≦1200, 100≦HV2<250, and 100≦HV1−HV2, and when the projected area circle equivalent diameter of the first particle is represented by d1 and the projected area circle equivalent diameter of the second particle is represented by d2, d1 and d2 satisfy the following relationships: 30 μm≦d1≦100 μm and 2 μm≦d2≦20 μm.

### BACKGROUND

1. Technical Field

The present invention relates to a composite particle, a powder core, a magnetic element, and a portable electronic device.

2. Related Art

Recently, the reduction in the size and weight of mobile devices such as notebook personal computers has become significant. Further, it has been planned to improve the performance of notebook personal computers to such an extent that they are equivalent to the performance of desktop personal computers.

In order to reduce the size and improve the performance of mobile devices in this manner, it is necessary to increase the frequency of a switching power supply. At present, the driving frequency of a switching power supply has been increased to about several hundred kilo hertz, however, accompanying this, it is necessary to also increase the driving frequency of a magnetic element such as a choke coil or an inductor which is built into a mobile device in response to the increase in frequency of the switching power supply.

For example, JP-A-2007-182594 discloses a ribbon composed of an amorphous alloy containing Fe, M (provided that M is at least one element selected from Ti, V, Zr, Nb, Mo, Hf, Ta, and W), Si, B, and C. It also discloses a magnetic core produced by laminating this ribbon and processing the resulting laminate by punching or the like. It is expected that with such a magnetic core, the AC magnetic properties are improved.

However, in the magnetic core produced from the ribbon, a significant increase in Joule loss due to an eddy current (an eddy current loss) may not be avoided in the case where the driving frequency of a magnetic element is further increased.

In order to solve such a problem, a powder core obtained by press-molding a mixture of a soft magnetic powder and a binding material (a binder) is used. In the powder core, a path in which an eddy current is generated is cut, and therefore, an attempt is made to reduce the eddy current loss.

Further, in the powder core, by binding the soft magnetic powder particles to one another with the binder, insulation is provided between the particles and the shape of the magnetic core is maintained. On the other hand, if the amount of the binder is too much, a decrease in the magnetic permeability of the powder core is inevitable.

Therefore, JP-A-2010-118486 proposes that such a problem is resolved by using a mixed powder of an amorphous soft magnetic powder and a crystalline soft magnetic powder. That is, since an amorphous metal has a higher hardness than a crystalline metal, by subjecting a crystalline soft magnetic powder to plastic deformation when performing compression-molding, it is possible to improve the packing ratio and increase the magnetic permeability.

However, depending on the composition of the amorphous soft magnetic powder or the crystalline soft magnetic powder, the particle diameter thereof, or the like, the packing ratio sometimes cannot be sufficiently increased due to a problem of segregation of particles, uneven dispersion thereof, and the like.

### SUMMARY

An advantage of some aspects of the invention is to provide a composite particle capable of producing a powder core having a high packing ratio and a high magnetic permeability, a powder core produced using this composite particle, a magnetic element including this powder core, and a portable electronic device including this magnetic element.

An aspect of the invention is directed to a composite particle including a first particle composed of a soft magnetic metallic material, and second particles composed of a soft magnetic metallic material having a different composition from that of the first particle and adhered to the first particle so as to cover the first particle, wherein when the Vickers hardness of the first particle is represented by HV1 and the Vickers hardness of the second particle is represented by HV2, HV1 and HV2 satisfy the following relationships: 250≦HV1≦1200, 100≦HV2<250, and 100≦HV1−HV2, and when the projected area circle equivalent diameter of the first particle is represented by d1 and the projected area circle equivalent diameter of the second particle is represented by d2, d1 and d2 satisfy the following relationships: 30 μm≦d1≦100 μm and 2 μm≦d2≦20 μm.

According to this, when an aggregate of the composite particles (a composite particle powder) is compressed and molded, the first particles and the second particles are uniformly distributed, and also the second particles can move such that they are deformed and penetrate into a gap between the first particles, and therefore, a composite particle capable of producing a powder core having a high packing ratio and a high magnetic permeability is obtained.

It is preferred that in the composite particle according to the aspect of the invention, the second particles are adhered to the first particle so as to cover at least 70% of the surface of the first particle.

According to this, a powder core having a high packing ratio can be obtained while suppressing a decrease in mechanical properties in a molded body such as a powder core to be produced from the composite particles.

It is preferred that in the composite particle according to the aspect of the invention, the second particles are bound to the first particle through a binding agent.

According to this, the first particle and the second particles can be reliably bound to each other, and thus, when a powder core is formed by compressing the composite particles, the first particles and the second particles can be uniformly distributed. Due to this, a powder core having a high packing ratio and a high magnetic permeability is obtained.

It is preferred that in the composite particle according to the aspect of the invention, the binding agent contains at least one of a silicone resin, an epoxy resin, and a phenolic resin as a constituent material.

According to this, the binding performance, the penetration performance into a gap, and the insulation performance of the binding agent can be further enhanced.

It is preferred that in the composite particle according to the aspect of the invention, the soft magnetic metallic material constituting the first particle and the soft magnetic metallic material constituting the second particle are each a crystalline metallic material, and the average crystal grain size in the first particle as measured by X-ray diffractometry is 0.2 times or more and 0.95 times or less the average crystal grain size in the second particle as measured by X-ray diffractometry.

According to this, the hardness, toughness, specific resistance, and the like of the first particle and the second particle can be controlled to be uniform, and thus, a powder core having a high packing ratio can be obtained.

It is preferred that in the composite particle according to the aspect of the invention, the soft magnetic metallic material constituting the first particle is an amorphous metallic material or a nanocrystalline metallic material, and the soft magnetic metallic material constituting the second particle is a crystalline metallic material.

According to this, the first particle has a high hardness, a high toughness, and a high specific resistance, and the second particle has a relatively low hardness, and therefore, the above-described metallic materials are useful as the constituent materials of these particles.

It is preferred that in the composite particle according to the aspect of the invention, the average crystal grain size in the second particle as measured by X-ray diffractometry is 30 μm or more and 200 μm or less.

According to this, the hardness of the second particle is optimized, and also the toughness, specific resistance, and the like of the composite particle are further optimized from the viewpoint that the particle is applied to use in a powder core or the like.

It is preferred that in the composite particle according to the aspect of the invention, the soft magnetic metallic material constituting the first particle is an Fe—Si-based material.

According to this, a first particle having a high magnetic permeability and a relatively high toughness is obtained.

It is preferred that in the composite particle according to the aspect of the invention, the soft magnetic metallic material constituting the second particle is any of pure Fe, an Fe—B-based material, an Fe—Cr-based material, and an Fe—Ni-based material.

According to this, a second particle having a relatively low hardness and a relatively high toughness is obtained.

It is preferred that in the composite particle according to the aspect of the invention, the composite particle is configured such that the mass ratio of the first particle to the second particle is 20:80≦the mass of the first particle:the mass of the second particle≦97:3.

According to this, the composite particle includes the second particles in an amount necessary and sufficient for covering the first particle. As a result, when the composite particles are compressed and molded into a powder core or the like, a product having a high packing ratio is obtained.

Another aspect of the invention is directed to a powder core including a compressed powder body obtained by compression-molding composite particles each including a first particle composed of a soft magnetic metallic material and second particles composed of a soft magnetic metallic material having a different composition from that of the first particle and adhered to the first particle so as to cover the first particle and a binding material which binds the composite particles, wherein when the Vickers hardness of the first particle is represented by HV1 and the Vickers hardness of the second particle is represented by HV2, HV1 and HV2 satisfy the following relationships: 250≦HV1≦1200, 100≦HV2<250, and 100≦HV1−HV2, and when the projected area circle equivalent diameter of the first particle is represented by d1 and the projected area circle equivalent diameter of the second particle is represented by d2, d1 and d2 satisfy the following relationships: 30 μm≦d1≦100 μm and 2 μm≦d2≦20 μm, and the second particles are deformed along the surface of the first particle.

According to this, a powder core having a high packing ratio and a high magnetic permeability is obtained.

It is preferred that in the powder core according to the aspect of the invention, the second particles are bound to the first particle through a binding agent.

According to this, since a composite particle in which the first particle and the second particles are reliably bound to each other is obtained, the first particles and the second particles are uniformly distributed, and thus, a powder core having a high packing ratio and a high magnetic permeability is obtained.

Still another aspect of the invention is directed to a magnetic element including the powder core according to the aspect of the invention.

According to this, a magnetic element whose reliability is high is obtained.

Yet another aspect of the invention is directed to a portable electronic device including the magnetic element according to the aspect of the invention.

According to this, a portable electronic device whose reliability is high is obtained.

### BRIEF DESCRIPTION OF THE DRAWINGS

Embodiments of the invention will be described with reference to the accompanying drawings, wherein like numbers reference like elements.

FIG. 1 is a cross-sectional view showing a composite particle according to an embodiment of the invention.

FIG. 2 is a cross-sectional view showing a composite particle according to an embodiment of the invention.

FIG. 3 is a schematic view (a plan view) showing a choke coil, to which a magnetic element according to a first embodiment of the invention is applied.

FIG. 4 is a schematic view (a transparent perspective view) showing a choke coil, to which a magnetic element according to a second embodiment of the invention is applied.

FIG. 5 is a perspective view showing a structure of a personal computer of a mobile type (or a notebook type), to which a portable electronic device including the magnetic element according to the embodiment of the invention is applied.

FIG. 6 is a perspective view showing a structure of a cellular phone (also including a PHS), to which a portable electronic device including the magnetic element according to the embodiment of the invention is applied.

FIG. 7 is a perspective view showing a structure of a digital still camera, to which a portable electronic device including the magnetic element according to the embodiment of the invention is applied.

### DESCRIPTION OF EXEMPLARY EMBODIMENTS

Hereinafter, a composite particle, a powder core, a magnetic element, and a portable electronic device according to embodiments of the invention will be described in detail based on preferred embodiments shown in the accompanying drawings.

### Composite Particle

A composite particle according to an embodiment of the invention includes a first particle composed of a soft magnetic metallic material and second particles composed of a soft magnetic metallic material having a different composition from that of the first particle and adhered to the first particle so as to cover the first particle, and a powder which is an aggregate of such composite particles is used as a starting material of a powder core or the like as a soft magnetic powder.

Hereinafter, the composite particle will be described in more detail.

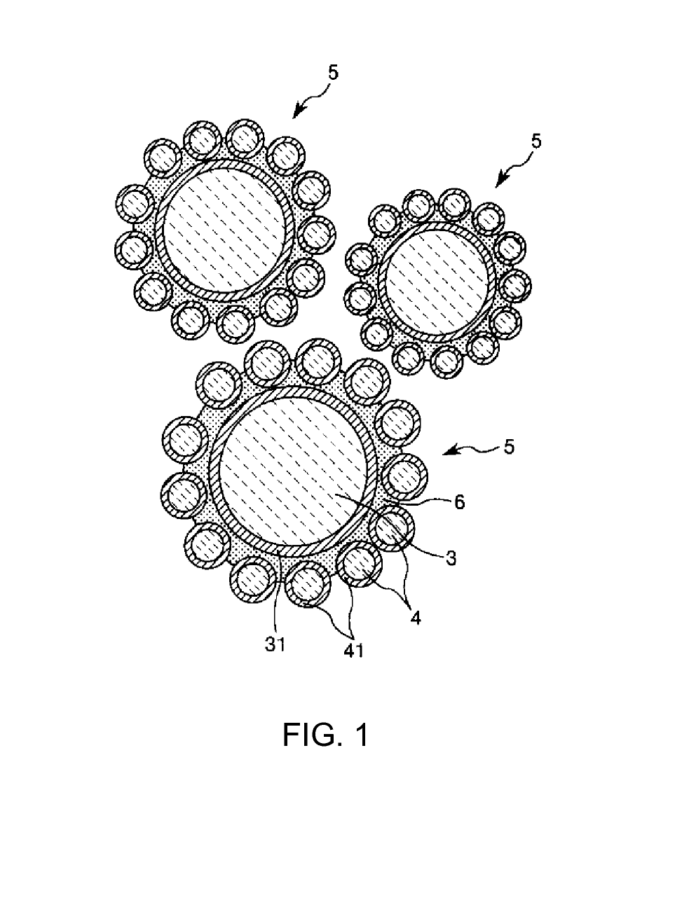

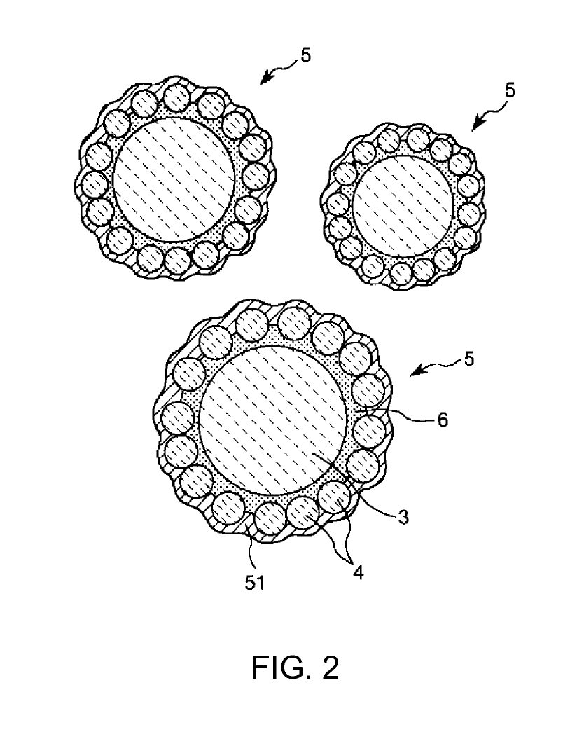

FIGS. 1 and 2 are each a cross-sectional view showing a composite particle according to an embodiment of the invention.

As shown in FIG. 1, a composite particle 5 includes a first particle 3 and second particles 4 adhered to the first particle 3 so as to cover the periphery thereof. The term “adhere” as used herein refers to a state where binding is achieved through a binding agent, and also refers to a state where adhesion is achieved through various attractive forces such as an intermolecular force, and the like. In FIG. 1, a state where the first particle 3 and the second particles 4 are bound to each other through a binding agent 6 is shown.

The composite particle 5 shown in FIG. 1 has an insulating layer 31 provided so as to cover the first particle 3 and an insulating layer 41 provided so as to cover the second particle 4.

Such a composite particle 5 satisfies a predetermined relationship in hardness and particle diameter between the first particle 3 and the second particle 4.

Specifically, the first particle 3 is composed of a soft magnetic metallic material, and when the Vickers hardness of the first particle 3 is represented by HV1, HV1 satisfies the following relationship: 250≦HV1≦1200. On the other hand, the second particle 4 is composed of a soft magnetic metallic material different from that of the first particle 3, and when the Vickers hardness of the second particle is represented by HV2, HV2 satisfies the following relationship: 100≦HV2<250, and HV1 and HV2 satisfy the following relationship: 100≦HV1−HV2.

Further, when the projected area circle equivalent diameter of the first particle 3 is represented by d1, d1 is 30 μm or more and 100 μm or less, and when the projected area circle equivalent diameter of the second particle 4 is represented by d2, d2 is 2 μm or more and 20 μm or less.

The composite particle 5 that satisfies such a relationship can produce a powder core having a high packing ratio when the composite particles 5 are compressed and molded into a powder core or the like. This is because the relationship in particle diameter between the first particle 3 and the second particle 4 is optimized so that the first particles 3 and the second particles 4 are uniformly distributed in a powder core, and also the second particles 4 are distributed so as to cover the first particles 3, and further the hardness of each particle and a difference in hardness between the particles are optimized, and thus, the second particles 4 penetrate into a gap between the first particles 3 so that the packing ratio of the soft magnetic metallic material in the entire powder core is increased. As a result, the overall packing ratio becomes more uniform and is further increased, and accordingly, a powder core having a high magnetic permeability and a high saturation magnetic flux density is obtained.

That is, in the case where the particle diameter or the hardness is not optimized, the first particles and the second particles are unevenly distributed when the composite particles are compressed, and as a result, a large gap may be left between the first particles. On the other hand, it is considered that according to the disclosure, the packing ratio is improved because the second particles 4 reliably penetrate into this gap. Further, at this time, if the second particle 4 is not deformed, a large gap may be generated between the first particle 3 and the second particle 4, but, in the case where the second particle 4 is moderately deformed, the packing performance thereof into the gap is improved, and thus, the overall packing ratio can be further increased.

By using such a composite particle 5, even if the first particle 3 has a low toughness, the second particles 4 provided so as to cover the first particle 3 compensate therefor, whereby a decrease in the toughness of a molded body such as a powder core can be suppressed. Accordingly, in the first particle 3, for example, a material having a high magnetic permeability or a high saturation magnetic flux density although having a low toughness, or a material having a low toughness and being inexpensive can be selected. In view of this, the composite particle 5 is particularly useful in that the range of choices for the material of the first particle 3 can be expanded.

In the case where the Vickers hardness HV1 of the first particle 3 is below the above-described lower limit, when the composite particles are compressed, the first particles 3 are largely deformed more than necessary, and thus, a state where the first particles 3 and the second particles 4 are uniformly distributed is deteriorated. This may lead to a decrease in the packing ratio of the soft magnetic metallic material in the powder core. Further, in the case where the Vickers hardness HV1 of the first particle 3 exceeds the above-described upper limit, when the composite particles are compressed, the second particles 4 are largely deformed more than necessary this time, and thus, a state where the first particles 3 and the second particles 4 are uniformly distributed is deteriorated just the same.

On the other hand, also in the case where the Vickers hardness HV2 of the second particle 4 is below the above-described lower limit, when the composite particles are compressed, the second particles 4 are largely deformed more than necessary, and thus, a state where the first particles 3 and the second particles 4 are uniformly distributed is deteriorated. Further, in the case where the Vickers hardness HV2 of the second particle 4 exceeds the above-described upper limit, when the composite particles are compressed, the first particles 3 are largely deformed more than necessary.

Further, in the case where HV1−HV2 is below the above-described lower limit, a difference between HV1 and HV2 is not sufficiently ensured, and even when a compression load is applied to the composite particles 5, the second particles 4 cannot be moderately deformed, and therefore, the second particles 4 cannot penetrate into a gap between the first particles 3.

The Vickers hardness HV1 or HV2 is calculated on the basis of the size of the cross-sectional area of an indentation formed by pressing an indenter onto a surface or a cross section of the first particle 3 or the second particle 4, the load applied when pressing the indenter, and the like. In the measurement, for example, a Micro Vickers Hardness Tester or the like is used.

HV1 preferably satisfies the following relationship: 300≦HV1≦1100, more preferably satisfies the following relationship: 350≦HV1≦1000.

Further, HV2 preferably satisfies the following relationship: 125≦HV2≦225, more preferably satisfies the following relationship: 150≦HV2≦200.

Further, HV1−HV2 preferably satisfies the following relationship: 125≦HV1−HV2≦700, more preferably satisfies the following relationship: 150≦HV1−HV2≦500. In the case where HV1−HV2 exceeds the above-described upper limit, the second particle 4 is excessively deformed depending on the particle diameter of the first particle 3 or the second particle 4, and the like, and the distribution of the first particles 3 and the second particles 4 may be uneven.

Further, in the case where the projected area circle equivalent diameter d1 of the first particle 3 is below the above-described lower limit, when the composite particles 5 are compressed, it becomes difficult to press a plurality of second particles 4 against the first particle 3, and thus, it becomes difficult to maintain the state where the second particles 4 are distributed so as to cover the first particle 3. Further, in the case where the projected area circle equivalent diameter d1 of the first particle 3 exceeds the above-described upper limit, a gap between the first particles 3 is inevitably increased, and as a result, when the composite particles 5 are compressed and molded into a powder core or the like, the packing ratio tends to be low.

On the other hand, also in the case where the projected area circle equivalent diameter d2 of the second particle 4 is below the above-described lower limit, a gap between the first particles 3 is relatively increased as compared with the size of the second particle 4, and therefore, this gap may not be completely packed with the second particles 4. As a result, when the composite particles 5 are compressed and molded into a powder core or the like, the packing ratio tends to be low. Further, in the case where the projected area circle equivalent diameter d2 of the second particle 4 exceeds the above-described upper limit, even if the second particle 4 is deformed, it becomes difficult for the second particle 4 to penetrate into a gap between the first particles 3, and as a result, when the composite particles 5 are compressed and molded into a powder core or the like, the packing ratio tends to be low.

The projected area circle equivalent diameter d1 or d2 is calculated as a diameter of a circle having the same area as that of an image of the first particle 3 or that of an image of the second particle 4 obtained by capturing an image of the composite particle 5 with a light microscope, an electron microscope, or the like.

Here, d1 is preferably 40 μm or more and 90 μm or less, more preferably 45 μm or more and 80 μm or less.

Here, d2 is preferably 5 μm or more and 17 μm or less, more preferably 7 μm or more and 15 μm or less.

Further, d1/d2 is preferably 3 or more and 12 or less, more preferably 4 or more and 10 or less. By setting d1/d2 to fall within the above-described range, it becomes easy to distribute the second particles 4 around the first particle 3 so as to more reliably cover the first particle 3. Due to this, when the composite particles 5 are compressed and molded into a powder core or the like, the first particles 3 and the second particles 4 can be uniformly distributed. Accordingly, a powder core having a high packing ratio and a high magnetic permeability is obtained.

The average circularity of each of the first particle 3 and the second particle 4 is preferably 0.5 or more and 1 or less, more preferably 0.6 or more and 1 or less. The first particle 3 and the second particle 4 having such an average circularity are relatively close to a true sphere, respectively, and therefore, also the composite particle 5 has a relatively high fluidity. Due to this, when the composite particles 5 are compressed and molded into a powder core or the like, the composite particles 5 are tightly packed, and thus, a powder core having a high packing ratio and a high magnetic permeability is obtained.

With respect to a powder composed of the composite particles 5, when a 50% cumulative particle diameter counted from a smaller diameter side in a cumulative particle size distribution on a mass basis as measured by a laser diffraction/scattering method is defined as D50, D50 is preferably 50 μm or more and 500 μm or less, more preferably 80 μm or more and 400 μm or less. Such a composite particle 5 is preferred from the viewpoint of producing a powder core having a high packing ratio since the particle diameter of the first particle 3 and the particle diameter of the second particle 4 are better balanced.

Further, with respect to a powder composed of the composite particles 5, when 10% and 90% cumulative particle diameters counted from a smaller diameter side in a cumulative particle size distribution on a mass basis as measured by a laser diffraction/scattering method are defined as D10 and D90, respectively, (D90−D10)/D50 is preferably 0.3 or more and 10 or less, more preferably 0.5 or more and 8 or less. Such a composite particle 5 is preferred particularly from the viewpoint of producing a powder core having a high packing ratio since the balance in particle diameter between the first particle 3 and the second particle 4 is moderately maintained, and above all, a variation in the particle diameter of the composite particle 5 is small.

Here, the soft magnetic metallic material constituting the first particle 3 is not particularly limited as long as it has a higher Vickers hardness than the soft magnetic metallic material constituting the second particle 4, and examples thereof include various Fe-based materials such as pure Fe, silicon steel (an Fe—Si-based material), permalloy (an Fe—Ni-based material), supermalloy, permendur (an Fe—Co-based material), Fe—Si—Al-based materials such as Sendust, Fe—Cr—Si-based materials, Fe—Cr-based materials, Fe—B-based materials, and ferrite-based stainless steel, and also various Ni-based materials, various Co-based materials, and various amorphous metallic materials. A composite material containing one or more types thereof may also be used.

Among these, an Fe—Si-based material is preferably used. The Fe—Si-based material has a high magnetic permeability and a relatively high toughness, and therefore is useful as the soft magnetic metallic material constituting the first particle 3. Examples of the Fe—Si-based material include Fe—Si materials, Fe—Si—B materials, Fe—Si—B—C materials, Fe—Si—Cr materials, and Fe—Si—Al materials.

Also as the soft magnetic metallic material constituting the second particle 4, for example, the above-described soft magnetic metallic materials are used.

Among these, any of pure Fe, an Fe—B-based material, an Fe—Cr-based material, and an Fe—Ni-based material is preferably used. These materials have a relatively low hardness and a relatively high toughness, and therefore are useful as the soft magnetic metallic material constituting the second particle 4. The “pure Fe” as used herein refers to iron containing extremely low amounts of carbon and other impurity elements, and the impurity content is 0.02% by mass or less.

As for the constituent materials of the first particle 3 and the second particle 4, a case where both of the first particle 3 and the second particle 4 are composed of a crystalline soft magnetic metallic material, or a case where the first particle 3 is composed of an amorphous or nanocrystalline soft magnetic metallic material, and the second particle 4 is composed of a crystalline soft magnetic metallic material can be exemplified.

Of these, the former is a case where both of the first particle 3 and the second particle 4 are composed of a crystalline soft magnetic metallic material. In this case, the hardness, toughness, specific resistance, and the like of both of the first particle and the second particle can be controlled to be uniform by suitably changing the condition for an annealing treatment, and the like to adjust the crystal grain size, and thus, a powder core having a high packing ratio can be obtained. Accordingly, the crystalline soft magnetic metallic material is useful as the constituent material of the first particle 3 and the second particle 4.

The average grain size of the crystalline structure present in the first particle 3 is preferably 0.2 times or more and 0.95 times or less, more preferably 0.3 times or more and 0.9 times or less the average grain size of the crystalline structure present in the second particle 4. According to this, the balance in hardness between the first particle 3 and the second particle 4 can be further optimized. That is, when the composite particles 5 are compressed, the second particles 4 are moderately deformed, whereby the packing ratio of the powder core can be particularly increased. In the case where the average grain size of the crystalline structure is below the above-described lower limit, the formation of such a crystalline structure in a stable manner while suppressing a variation ingrain size is sometimes accompanied by difficulty in adjusting the production condition.

The average grain size of such a crystalline structure can be calculated from the width of a diffraction peak obtained by, for example, X-ray diffractometry.

Further, the average grain size of the crystalline structure present in the second particle 4 is preferably 30 μm or more and 200 μm or less, more preferably 40 μm or more and 180 μm or less. The second particle 4 having such an average grain size is optimized particularly in terms of hardness, and also the toughness, specific resistance, and the like thereof are further optimized from the viewpoint that the composite particle 5 is applied to use in a powder core, and the like.

The latter is a case where the first particle 3 is composed of an amorphous or nanocrystalline soft magnetic metallic material, and the second particle 4 is composed of a crystalline soft magnetic metallic material. In this case, the hardness, toughness, and specific resistance of the amorphous or nanocrystalline material are very high, and therefore, the amorphous or nanocrystalline material is useful as the constituent material of the first particle 3. On the other hand, the hardness of the crystalline material is relatively low, and therefore, the crystalline material is useful as the constituent material of the second particle 4.

The “amorphous soft magnetic metallic material” as used herein refers to a material for which diffraction peaks are not detected when an X-ray diffraction spectrum of the first particle 3 is obtained. The “nanocrystalline soft magnetic metallic material” as used herein refers to a material in which the average grain size of the crystalline structure as measured by X-ray diffractometry is less than 1 μm, and the “crystalline soft magnetic metallic material” as used herein refers to a material in which the average grain size of the crystalline structure as measured by X-ray diffractometry is 1 μm or more.

Examples of the amorphous soft magnetic metallic material include Fe—Si—B-based, Fe—B-based, Fe—Si—B—C-based, Fe—Si—B—Cr-based, Fe—Si—B—Cr—C-based, Fe—Co—Si—B-based, Fe—Zr—B-based, Fe—Ni—Mo—B-based, and Ni—Fe—Si—B-based materials.

As the nanocrystalline soft magnetic metallic material, for example, a microcrystal of nanometer order deposited by crystallization of an amorphous soft magnetic metallic material is used.

In the composite particle 5 shown in FIG. 1, a plurality of second particles 4 are adhered to the first particle 3 so as to cover the surface thereof, and the abundance ratio of the first particle 3 to the second particle 4 on a mass basis at this time is preferably 20:80 or more and 97:3 or less, more preferably 30:70 or more and 90:10 or less. By setting the abundance ratio to fall within the above-described range, the composite particle 5 includes the second particles 4 in an amount necessary and sufficient for covering the first particle 3. As a result, when the composite particles 5 are compressed and molded into a powder core or the like, a product having a high packing ratio is obtained.

If the abundance ratio is below the above-described lower limit, although it depends on the constituent materials of the first particle 3 and the second particle 4, the abundance ratio of the first particle 3 having a high hardness is decreased, and therefore, the mechanical property of the entire molded body such as a powder core may be deteriorated. On the other hand, if the abundance ratio exceeds the above-described upper limit, the abundance ratio of the first particle 3 is increased and the abundance ratio of the second particle 4 is relatively decreased, and therefore, a gap between the first particles 3 may not be completely packed with the second particles 4, resulting in decreasing the packing ratio.

The second particles 4 preferably cover the entire surface of the first particle 3, but may cover a part of the surface thereof. In this case, the second particles 4 cover preferably at least 50% of the surface of the first particle 3, more preferably at least 70% thereof. Particularly, in the case where the second particles 4 cover at least 70% thereof, it is considered that theoretically, a state in which the second particles 4 can be no more directly adhered to the surface of the first particle 3 has been reached. That is, such a state can be regarded as a state in which the second particles 4 cover substantially the entire surface of the first particle 3. In such a state, a powder core having a high packing ratio can be obtained while suppressing a decrease in mechanical property in a molded body such as a powder core.

The binding agent 6 is interposed between the first particle 3 and the second particle 4, and binds the first particle 3 and the second particle 4 to each other. By using the binding agent 6, the first particle 3 and the second particle 4 can be reliably bound to each other, and therefore, when the composite particles 5 are compressed to form a powder core, the first particles 3 and the second particles 4 can be uniformly distributed. Due to this, a powder core having a high packing ratio and a high magnetic permeability is obtained. Further, the binding agent 6 also has a function to bind the composite particles 5 to one another such that the binding agent 6 is extruded from between the particles when the composite particles 5 are compressed.

As the constituent material of such a binding agent 6, for example, an organic binder such as a silicone resin, an epoxy resin, a phenolic resin, a polyamide resin, a polyimide resin, or a polyphenylene sulfide resin is preferably used. The organic binder has an excellent binding ability and an ability to penetrate into a gap, and spreads thin and is interposed between particles, and therefore is useful as the binding agent 6. Further, the organic binder insulates particles from one another in the powder core and can cut off an induced current accompanying an electromotive force generated by electromagnetic induction. As a result, a powder core whose Joule loss due to an induction current is small is obtained.

From the viewpoint of a binding ability, an ability to penetrate into a gap, and an insulating ability, as the constituent material of the binding agent 6, particularly, a material containing at least one of a silicone resin, an epoxy resin, and a phenolic resin is preferably used.

The ratio of the amount of the binding agent 6 to the total amount of the first particles 3 and the second particles 4 is preferably 0.5% by mass or more and 10% by mass or less, more preferably 1% by mass or more and 5% by mass or less. According to this, a decrease in magnetic property such as magnetic permeability can be suppressed while suppressing the Joule loss by the binding agent 6.

To the binding agent 6, in addition to the above-described binder, a lubricant may be added. By adding a lubricant, frictional resistance between the first particle 3 and the second particle 4, and between the composite particles 5 is reduced, and therefore, heat generation or the like when forming the composite particles 5 can be suppressed. This can suppress oxidation of the first particle 3 and the second particle 4, degeneration of the binding agent 6, and the like accompanying heat generation. Further, by exuding the lubricant when compression-molding the composite particles 5, a defect such as mold galling can be suppressed. As a result, the composite particle 5 capable of efficiently producing a high-quality powder core is obtained.

The addition amount of the lubricant is preferably 0.1% by mass or more and 2% by mass or less, more preferably 0.2% by mass or more and 1% by mass or less in the composite particle 5.

Examples of the constituent material of the lubricant include compounds (metal salts of fatty acids) of higher fatty acids such as lauric acid, stearic acid, succinic acid, stearyl lactic acid, lactic acid, phthalic acid, benzoic acid, hydroxystearic acid, ricinoleic acid, naphthenic acid, oleic acid, palmitic acid, and erucic acid with metals such as Li, Na, Mg, Ca, Sr, Ba, Zn, Cd, Al, Sn, Pb, and Cd; silicone-based compounds such as dimethylpolysiloxanes and modified products thereof, carboxyl-modified silicones, α-methylstyrene-modified silicones, α-olefin-modified silicones, polyether-modified silicones, fluorine-modified silicones, specially modified hydrophilic silicones, olefin polyether-modified silicones, epoxy-modified silicones, amino-modified silicones, amide-modified silicones, and alcohol-modified silicones; and natural or synthetic resin derivatives such as paraffin wax, microcrystalline wax, and carnauba wax. Among these, one type or two or more types in combination may be used.

Further, to the binding agent 6, a higher fatty acid such as lauric acid, myristic acid, palmitic acid, stearic acid, arachidic acid, oleic acid, or linoleic acid; an alcohol such as a polyhydric alcohol, a polyglycol, or a polyglycerol; a fatty acid ester such as palm oil; an adipate ester such as dibutyl adipate; a sebacate ester such as dibutyl sebacate; polyvinylpyrrolidone, a polyether, polypropylene carbonate, ethylenebisstearoamide, sodium alginate, agar, gum. Arabic, a resin, sucrose, or an ethylene-vinyl acetate copolymer (EVA) may be added. Among these, one type or two or more types in combination can be used.

The addition amount of such a component is preferably 0.1% by mass or more and 10% by mass or less, more preferably 1% by mass or more and 8% by mass or less in the binding agent 6.

Further, the binding agent 6 may contain, in addition to the above-described components, an antioxidant, a degreasing accelerator, a surfactant, or the like.

Further, between the first particle 3 and the second particle 4 shown in FIG. 1, other than the binding agent 6, the insulating layers 31 and 41 are interposed.

As the constituent material of the insulating layers 31 and 41, an inorganic binder, for example, a phosphate such as magnesium phosphate, calcium phosphate, zinc phosphate, manganese phosphate, or cadmium phosphate, a silicate (liquid glass) such as sodium silicate, soda-lime glass, borosilicate glass, lead glass, aluminosilicate glass, borate glass, sulfate glass, or the like is preferably used. An inorganic binder has a particularly excellent insulating ability, and therefore can decrease the Joule loss due to an induction current to particularly a low level. Further, an inorganic binder has a relatively high hardness, and therefore, the insulating layers 31 and 41 composed of an inorganic binder are hardly cut off even when the composite particles 5 are compressed. In addition, by providing the insulating layers 31 and 41 composed of an inorganic binder, the adhesiveness and affinity between the respective particles composed of a metallic material and the insulating layers are improved, and the insulating performance between the particles can be particularly enhanced.

The average thickness of each of the insulating layers 31 and 41 is preferably 0.3 μm or more and 10 μm or less, more preferably 0.5 μm or more and 8 μm or less. According to this, a decrease in the overall magnetic permeability and the like can be suppressed while sufficiently insulating between the first particle 3 and the second particle 4.

The insulating layers 31 and 41 may not cover the entire surfaces of the first particle 3 and the second particle 4, and may cover only a part thereof.

Further, the insulating layers 31 and 41 may be provided as needed. For example, as shown in FIG. 2, instead of the omitted insulating layers 31 and 41, an insulating layer 51 similar to the insulating layers 31 and 41 may be provided so as to cover the entire composite particle 5. By doing this, the insulating layer can ensure the insulation performance between the composite particles 5 and also reinforce the composite particles 5 to prevent the composite particles 5 from being fractured when the composite particles 5 are compressed. Such an insulating layer 51 covering the entire composite particle 5 can also be constituted in the same manner as the insulating layers 31 and 41.

The first particle 3 and the second particle 4 as described above are produced by, for example, any of various powdering processes such as an atomization process (such as a water atomization process, a gas atomization process, or a spinning water atomization process), a reduction process, a carbonyl process, and a pulverization process.

The first particle 3 and the second particle 4 are preferably produced by an atomization process among the above-described processes, and more preferably produced by a water atomization process or a spinning water atomization process. The atomization process is a process in which a metal powder is produced by causing a molten metal (a metal melt) to collide with a fluid (a liquid or a gas) sprayed at a high speed to atomize the metal melt, followed by cooling. By producing the first particle 3 and the second particle 4 through such an atomization process, a powder having a shape closer to a sphere and having a uniform particle diameter can be efficiently produced. Due to this, by using such first particles 3 and second particles 4, a powder core having a high packing ratio and a high magnetic permeability is obtained.

In the case where a water atomization process is used as the atomization process, the pressure of water to be sprayed to the molten metal (hereinafter referred to as “atomization water”) is not particularly limited, but is preferably about 75 MPa or more and 120 MPa or less (750 kgf/cm² or more and 1200 kgf/cm² or less), more preferably about 90 MPa or more and 120 MPa or less (900 kgf/cm² or more and 1200 kgf/cm² or less).

The temperature of the atomization water is also not particularly limited, but is preferably about 1° C. or higher and 20° C. or lower.

The atomization water is often sprayed in a cone shape such that it has a vertex on the fall path of the metal melt and the outer diameter gradually decreases downward. In this case, the vertex angle θ of the cone formed by the atomization water is preferably about 10° or more and 40° or less, more preferably about 15° or more and 35° or less. According to this, a soft magnetic powder having a composition as described above can be reliably produced.

Further, the obtained first particle 3 and second particle 4 may be subjected to an annealing treatment as needed.

### Method for Producing Composite Particle

Next, a method for producing the composite particle 5 shown in FIG. 1 will be described.

[1] First, the insulating layer 31 is formed for the first particle 3. When forming the insulating layer 31, for example, a method in which a liquid obtained by dissolving or dispersing a starting material is applied to the surface of the first particle 3 is also used, but preferably a method in which a starting material is mechanically adhered thereto is used. By doing this, the insulating layer 31 having high adhesiveness to the first particle 3 is obtained.

When forming the insulating layer 31 by mechanically adhering a starting material, for example, a device which causes mechanical compression and friction for a mixture of the first particles 3 and the starting material of the insulating layer 31 is used. Specifically, any type of pulverizer such as a hammer mill, a disk mill, a roller mill, a ball mill, a planetary mill, or a jet mill, or a high-speed impact type mechanical particle compounding device such as Hybridization (registered trademark) or Cryptron (registered trademark), a compression shear type mechanical particle compounding device such as Mechanofusion (registered trademark) or Theta Composer (registered trademark), a mixing shear friction type mechanical particle compounding device such as Mechanomill, CF Mill, or a friction mixer, or the like is used. By causing compression and friction using such a device, the starting material (solid) of the insulating layer 31 is softened or melted and uniformly and firmly adhered to the surface of the first particle 3, whereby the insulating layer 31 covering the first particle 3 is formed. Further, even if the first particle 3 has an indented surface, by pressing the starting material against the surface of the first particle 3, the insulating layer 31 having a uniform thickness can be formed irrespective of the indented surface. Since a liquid is not used, the insulating layer 31 can be formed under a dry condition or in an inert gas atmosphere, and thus, the degradation or deterioration of the first particle 3 by moisture can be suppressed.

At this time, it is preferred to adjust the compression condition and the friction condition so that the first particle 3 is not deformed or the like as much as possible while forming the insulating layer 31. By doing this, in the step described below, the second particle 4 can be efficiently adhered to the first particle 3.

In the case where the above-described inorganic binder is used as the constituent material of the insulating layer 31, the softening point thereof is preferably about 100° C. or higher and 500° C. or lower.

Further, since the action of compression and friction works when forming the insulating layer 31, even if a foreign substance, a passive film, or the like is adhered to the surface of the first particle 3, the insulating layer 31 can be formed while removing such a material, and thus, the adhesiveness is improved.

It is also possible to form the insulating layer 41 for the second particle 4 in the same manner as described above. Also in this case, it is preferred to adjust the compression condition and the friction condition so that the second particle 4 is not deformed or the like as much as possible while forming the insulating layer 41.

[2] Subsequently, the binding agent 6 is adhered so as to cover the surface of the first particle 3 having the insulating layer 31 formed thereon. Also when adhering the binding agent 6, for example, a method in which a liquid obtained by dissolving or dispersing a starting material is applied to the surface of the first particle 3 having the insulating layer 31 formed thereon is also used, but preferably a method in which a starting material is mechanically adhered thereto is used. By doing this, the binding agent 6 can be firmly adhered to the first particle 3 having the insulating layer 31 formed thereon.

Also when adhering such a binding agent 6, for example, a device which causes mechanical compression and friction as described above is used. By causing compression and friction as described above, the starting material (solid) of the binding agent 6 is softened or melted and uniformly and firmly adhered to the surface of the insulating layer 31, whereby the first particle 3 having the binding agent 6 adhered thereto is formed. Further, even if the insulating layer 31 has an indented surface, by pressing the starting material against the surface of the insulating layer 31, a uniform amount of the binding agent 6 can be adhered thereto irrespective of the indented surface.

Also in this case, it is preferred to adjust the compression condition and the friction condition so that the first particle 3 is not deformed or the like as much as possible while adhering the binding agent 6.

In this embodiment, the binding agent 6 is adhered only to the first particle 3, however, the binding agent 6 may be adhered also to the second particle 4 as needed.

[3] Subsequently, the second particles 4 with the insulating layer 41 are adhered to the first particles 3 with the insulating layer 31 having the binding agent 6 adhered thereto, whereby the composite particles 5 are obtained.

Also when adhering the second particles 4 to the first particles 3, for example, a device which causes mechanical compression and friction as described above is used. That is, the first particles 3 with the insulating layer 31 having the binding agent 6 adhered thereto and the second particles 4 with the insulating layer 41 are fed to the device to achieve adhesion by the action of compression and friction. At this time, a load at which a member that has an action of compression and friction in the device presses a material to be treated varies depending on the size or the like of the device, but is, for example, about 30 N or more and 500 N or less. Further, in the case where a member that has an action of compression and friction presses a material to be treated while rotating in the device, the rotation speed of the member is preferably adjusted at about 300 rpm or more and 1200 rpm or less.

By causing such compression and friction, the second particles 4 are adhered to the surfaces of the first particles 3 with the insulating layer 31 while maintaining the particle shape thereof. At this time, since the second particles 4 have a smaller diameter than the first particles 3, the second particles 4 are distributed so as to dodge the first particles 3. As a result, the second particles 4 are uniformly distributed such that they cover the first particles 3. The composite particles 5 are obtained in this manner, and these composite particles 5 contribute to an increase in the overall packing ratio when they are compressed and molded. Eventually, the composite particles 5 contribute to the production of a powder core having excellent magnetic properties such as magnetic permeability and saturation magnetic flux density.

Further, due to the heat generated by compression and friction, the binding agent 6 is melted and the melted binding agent 6 binds the first particles 3 to the second particles 4. In the case where the binding is not sufficient or the like, the binding agent 6 may be additionally added when mixing as needed.

### Powder Core and Magnetic Element

The magnetic element of the embodiment of the invention can be applied to a variety of magnetic elements provided with a magnetic core such as a choke coil, an inductor, a noise filter, a reactor, a transformer, a motor, and an electric generator. Further, the powder core of the embodiment of the invention can be applied to magnetic cores provided in these magnetic elements.

Hereinafter, two types of choke coils will be described as representative examples of the magnetic element.

### First Embodiment

First, a choke coil to which a magnetic element according to a first embodiment of the invention is applied will be described.

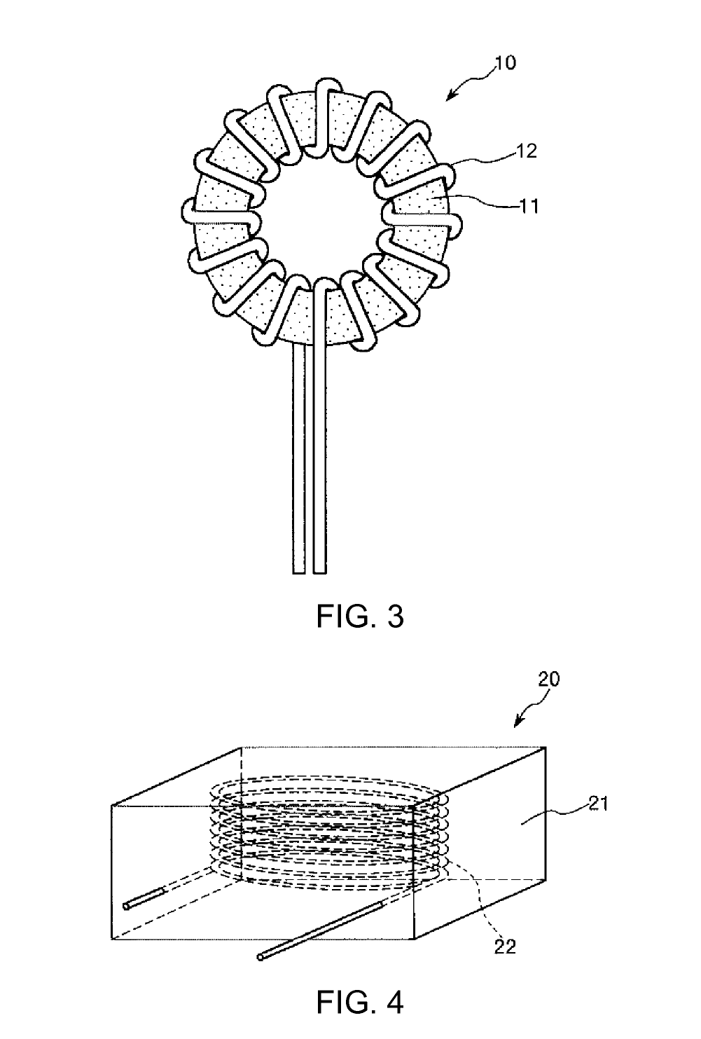

FIG. 3 is a schematic view (a plan view) showing a choke coil to which the magnetic element according to the first embodiment of the invention is applied.

A choke coil 10 shown in FIG. 3 includes a ring-shaped (toroidal) powder core 11 and a conductive wire 12 wound around the powder core 11. Such a choke coil 10 is generally referred to as “toroidal coil”.

The powder core 11 is obtained by mixing a powder composed of the composite particles of the embodiment of the invention, a binding material provided as needed, and an organic solvent, supplying the obtained mixture in a mold, and press-molding the mixture.

Examples of a constituent material of the binding material to be used for producing the powder core 11 include the above-described organic binders and inorganic binders, however, preferably, an organic binder is used, and more preferably, a thermosetting polyimide or epoxy resin is used. Such a resin material is easily cured by heating, and also has excellent heat resistance. Accordingly, such a material can facilitate the production of the powder core 11, and also can enhance the heat resistance.

The ratio of the amount of the binding material to the amount of the composite particles 5 varies slightly depending on the intended magnetic flux density of the powder core 11 to be produced, an acceptable level of eddy current loss, and the like, but is preferably about 0.5% by mass or more and 5% by mass or less, more preferably about 1% by mass or more and 3% by mass or less. According to this, the density of the powder core 11 is ensured to some extent while reliably insulating the composite particles 5 from one another, whereby a significant decrease in the magnetic permeability of the powder core 11 can be prevented. As a result, a powder core 11 having a higher magnetic permeability and a lower loss is obtained.

The organic solvent is not particularly limited as long as it can dissolve the binding material, but examples thereof include various solvents such as toluene, isopropyl alcohol, acetone, methyl ethyl ketone, chloroform, and ethyl acetate.

To the above-described mixture, any of a variety of additives may be added for an arbitrary purpose as needed.

Such a binding material ensures the shape retention of the powder core 11 and also ensures the insulation between the composite particles 5. Accordingly, even if the insulating layers 31 and 41 are omitted, a powder core whose iron loss has been decreased to a low level is obtained.

Examples of a constituent material of the conductive wire 12 include highly conductive materials such as metallic materials (such as Cu, Al, Ag, Au, and Ni) and alloys containing such a metallic material.

It is preferred that on the surface of the conductive wire 12, an insulating surface layer is provided. According to this, a short circuit between the powder core 11 and the conductive wire 12 can be reliably prevented.

Examples of a constituent material of such a surface layer include various resin materials.

Next, a method for producing the choke coil 10 will be described.

First, the composite particles 5 (the composite particles of the embodiment of the invention), a binding material, all sorts of necessary additives, and an organic solvent are mixed, whereby a mixture is obtained.

Subsequently, the mixture is dried to obtain a block-shaped dry material. Then, the thus obtained dry material is pulverized, whereby a granular powder is formed.

Subsequently, this mixture or the granular powder is molded into a shape of a powder core to be produced, whereby a molded body is obtained.

A molding method in this case is not particularly limited, however, the examples thereof include press-molding, extrusion-molding, and injection-molding. The shape and size of this molded body are determined in anticipation of shrinkage when heating the molded body in the subsequent step.

Subsequently, by heating the obtained molded body, the binding material is cured, whereby the powder core 11 is obtained. The heating temperature at this time varies slightly depending on the composition of the binding material and the like, however, in the case where the binding material is composed of an organic binder, it is set to preferably about 100° C. or higher and 500° C. or lower, more preferably about 120° C. or higher and 250° C. or lower. The heating time varies depending on the heating temperature, but is set to about 0.5 hours or more and 5 hours or less.

According to the above-described method, the choke coil (the magnetic element of the embodiment of the invention) 10 including the powder core (the powder core of the embodiment of the invention) obtained by press-molding the composite particles of the embodiment of the invention and the conductive wire 12 wound around the powder core 11 along the outer peripheral surface thereof is obtained. By using the composite particles 5 in the production of such a powder core 11, the first particles 3 and the second particles 4 are uniformly distributed in the powder core 11, and also the second particles 4 penetrate into a gap between the first particles 3. As a result, a powder core 11 having a high packing ratio and therefore having a high magnetic permeability and a high saturation magnetic flux density is obtained. Accordingly, the choke coil 10 including the powder core 11 has excellent magnetic responsivity and a low loss such that the loss (iron loss) in a high-frequency range is low. Moreover, a decrease in the size of the choke coil 10, an increase in rated current, and a decrease in the amount of heat generation can be easily realized. That is, a high-performance choke coil 10 is obtained.

### Second Embodiment

Next, a choke coil to which a magnetic element according to a second embodiment of the invention is applied will be described.

FIG. 4 is a schematic view (a transparent perspective view) showing a choke coil to which the magnetic element according to the second embodiment of the invention is applied.

Hereinafter, the choke coil according to the second embodiment will be described, however, different points from the choke coil according to the first embodiment described above will be mainly described and the description of the same matter will be omitted.

As shown in FIG. 4, a choke coil 20 according to this embodiment includes a conductive wire 22 formed into a coil and embedded inside a powder core 21. That is, the choke coil 20 is obtained by molding the conductive wire 22 with the powder core 21.

As the choke coil 20 having such a configuration, a relatively small choke coil is easily obtained. In the case where such a small choke coil 20 is produced, the powder core 21 having a high magnetic permeability, a high magnetic flux density, and a low loss exhibits its action and advantage more effectively. That is, the choke coil 20 which has a low loss and generates low heat so as to be able to cope with a high current although it has a smaller size is obtained.

Further, since the conductive wire 22 is embedded inside the powder core 21, a void is hardly generated between the conductive wire 22 and the powder core 21. According to this, vibration of the powder core 21 due to magnetostriction is prevented, and thus, it is also possible to prevent the generation of noise accompanying this vibration.

In the case where the choke coil 20 according to this embodiment as described above is produced, first, the conductive wire 22 is disposed in a cavity of a mold, and also the composite particles of the embodiment of the invention are packed in the cavity. In other words, the composite particles are packed therein so that the conductive wire 22 is embedded therein.

Subsequently, the composite particles are compressed together with the conductive wire 22, whereby a molded body is obtained.

Subsequently, in the same manner as the above-described first embodiment, the obtained molded body is subjected to a heat treatment. By doing this, the choke coil 20 is obtained.

### Portable Electronic Device

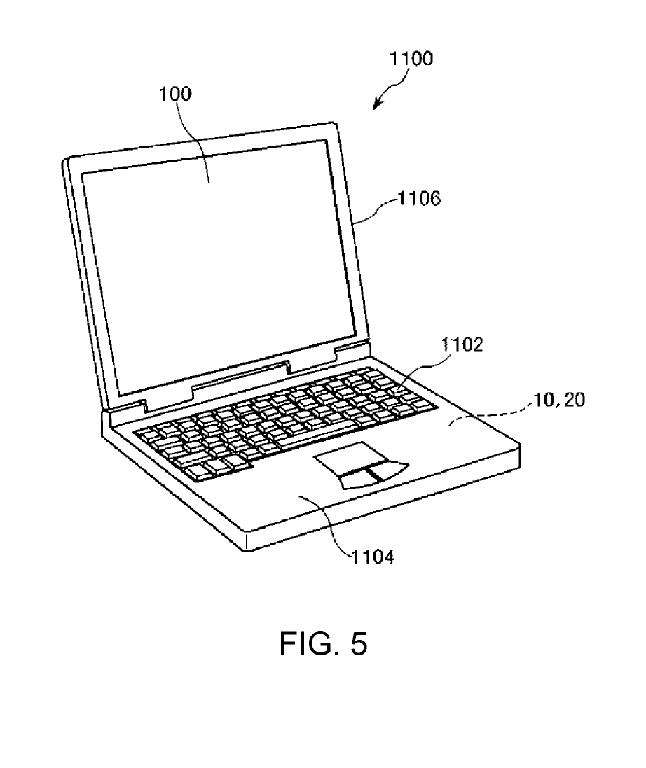

Next, a portable electronic device (the portable electronic device of the embodiment of the invention) including the magnetic element of the embodiment of the invention will be described with reference to FIGS. 5 to 7.

FIG. 5 is a perspective view showing a structure of a personal computer of a mobile type (or a notebook type), to which a portable electronic device including the magnetic element of the embodiment of the invention is applied. In this drawing, a personal computer 1100 includes a main body 1104 provided with a key board 1102, and a display unit 1106 provided with a display section 100. The display unit 1106 is supported rotatably with respect to the main body 1104 via a hinge structure. Such a personal computer 1100 has built-in choke coils 10 and 20.

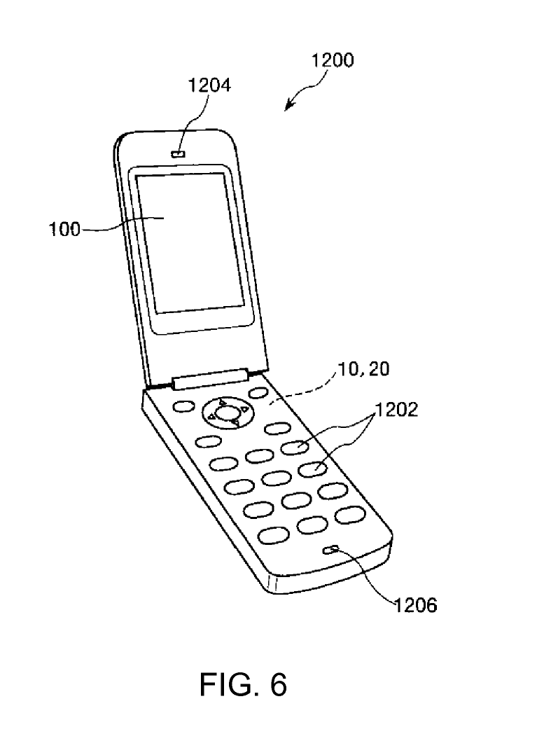

FIG. 6 is a perspective view showing a structure of a cellular phone (also including a PHS), to which a portable electronic device including the magnetic element of the embodiment of the invention is applied. In this drawing, a cellular phone 1200 includes a plurality of operation buttons 1202, an earpiece 1204, and a mouthpiece 1206, and between the operation buttons 1202 and the earpiece 1204, a display section 100 is placed. Such a cellular phone 1200 has built-in choke coils 10 and 20, each of which functions as a filter, an oscillator, or the like.

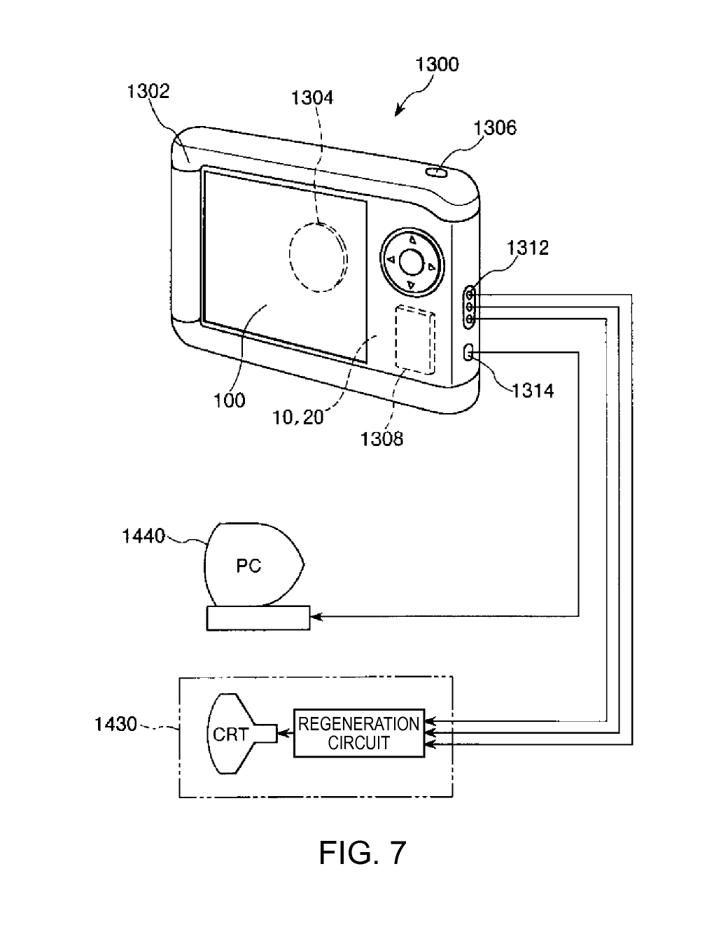

FIG. 7 is a perspective view showing a structure of a digital still camera, to which a portable electronic device including the magnetic element of the embodiment of the invention is applied. In this drawing, connection to external apparatuses is also briefly shown. A usual camera exposes a silver salt photographic film to light on the basis of an optical image of a subject. On the other hand, a digital still camera 1300 generates an imaging signal (an image signal) by photoelectrically converting an optical image of a subject into the imaging signal with an imaging device such as a CCD (Charge Coupled Device).

On a back surface of a case (body) 1302 in the digital still camera 1300, a display section is provided, and the display section is configured to perform display on the basis of the imaging signal of the CCD. The display section functions as a finder which displays a subject as an electronic image. Further, on a front surface side (on a back surface side in the drawing) of the case 1302, a light receiving unit 1304 including an optical lens (imaging optical system), a CCD, and the like is provided.

When a person who takes a picture confirms an image of a subject displayed on the display section and pushes a shutter button 1306, an imaging signal of the CCD at that time is transferred to a memory 1308 and stored there. Further, a video signal output terminal 1312 and an input/output terminal 1314 for data communication are provided on a side surface of the case 1302 in the digital still camera 1300. As shown in the drawing, a television monitor 1430 and a personal computer 1440 are connected to the video signal output terminal 1312 and the input/output terminal 1314 for data communication, respectively, as needed. Moreover, the digital still camera 1300 is configured such that the imaging signal stored in the memory 1308 is output to the television monitor 1430 or the personal computer 1440 by a predetermined operation. Such a digital still camera 1300 has built-in choke coils 10 and 20.

Incidentally, the portable electronic device including the magnetic element of the embodiment of the invention can be applied to, other than the personal computer (mobile personal computer) shown in FIG. 5, the cellular phone shown in FIG. 6, and the digital still camera shown in FIG. 7, for example, inkjet type ejection apparatuses (e.g., inkjet printers), laptop personal computers, televisions, video cameras, videotape recorders, car navigation devices, pagers, electronic notebooks (including those having a communication function), electronic dictionaries, pocket calculators, electronic game devices, word processors, work stations, television telephones, television monitors for crime prevention, electronic binoculars, POS terminals, medical devices (e.g., electronic thermometers, blood pressure meters, blood sugar meters, electrocardiogram monitoring devices, ultrasound diagnostic devices, and electronic endoscopes), fish finders, various measurement devices, gauges (e.g., gauges for vehicles, airplanes, and ships), flight simulators, and the like.

Hereinabove, the composite particle, the powder core, the magnetic element, and the portable electronic device according to the invention have been described based on the preferred embodiments, but the invention is not limited thereto.

For example, in the above-described embodiments, as the application example of the composite particle of the invention, the powder core is described, however, the application example is not limited thereto, and for example, the application example may be a compressed powder body such as a magnetic screening sheet or a magnetic head.

### EXAMPLES

Hereinafter, specific examples of embodiments of the invention will be described.

1. Production of Powder core and Choke Coil

### Sample No. 1

<1> First, composite particles including first particles composed of an Fe-6.5 mass % Si alloy and second particles composed of an Fe-50 mass % Ni alloy and bound to the first particles through a binding agent were prepared. These first particles and second particles were obtained by melting the respective starting materials in a high-frequency induction furnace and powdering the melted materials by a water atomization process.

Further, as the first particles and the second particles, those having an insulating layer of a phosphate glass having an average thickness of 2 μm formed on the surface thereof were used, respectively. The phosphate glass was a SnO—P₂O₅—MgO glass (SnO: 62 mol %, P₂O₅: 33 mol %, and MgO: 5 mol %) having a softening point of 404° C. Further, when forming the insulating layer, a mechanical particle compounding device was used.

<2> Subsequently, the first particles having the insulating layer formed thereon and an epoxy resin (a binding agent) were fed to a mechanical particle compounding device, whereby the binding agent was adhered to the surfaces of the first particles.

<3> Subsequently, the first particles with the insulating layer having the binding agent adhered thereto and the second particles with the insulating layer were fed to a mechanical particle compounding device, and the second particles with the insulating layer were bound to the first particles with the insulating layer so as to cover the first particles, whereby composite particles were obtained. To the mechanical particle compounding device, the first particles with the insulating layer having the binding agent adhered thereto and the second particles with the insulating layer were fed such that the mass ratio of the first particles to the second particles was 10:90.

The obtained composite particle was cut, and for the cross section, the hardness was measured using a micro-Vickers hardness meter. The measured Vickers hardnesses HV1 and HV2 of the cross sections of the first particle and the second particle are shown in Table 1.

Further, the obtained composite particles were observed by a scanning electron microscope, and images of the respective particles were obtained. Then, the equivalent circle diameters were measured from the images of the respective particles, and the measured equivalent circle diameters of the first particle and the second particle, d1 and d2 are shown in Table 1. Incidentally, as a result of the observation, the composite particle was configured such that the second particles were distributed so as to cover the surface of the first particle. Further, the second particles were distributed so as to cover 70% of the surface of the first particle (coverage: 70%).

<4> Subsequently, the obtained composite particles, an epoxy resin (a binding material), and toluene (an organic solvent) were mixed, whereby a mixture was obtained. The addition amount of the epoxy resin was set to 2 parts by mass with respect to 100 parts by mass of the composite particles.

<5> Subsequently, the obtained mixture was stirred, and then, dried by heating at 60° C. for 1 hour, whereby a block-shaped dry material was obtained. Then, this dry material was sieved through a sieve with a mesh size of 500 μm to pulverize the dry material, whereby a granular powder was obtained.

<6> Subsequently, the obtained granular powder was packed in a mold, and a molded body was obtained according to the following molding condition.

Molding Condition
Molding process: press-molding
Shape of molded body: ring
Size of molded body: outer diameter: 28 mm, inner diameter: 14 mm, thickness: 10.5 mm
Molding pressure: 20 t/cm² (1.96 GPa)

<7> Subsequently, the molded body was heated in an air atmosphere at 450° C. for 0.5 hours to cure the binding material. By doing this, a powder core was obtained.

<8> Subsequently, by using the obtained powder core, a choke coil (a magnetic element) shown in FIG. 3 was produced according to the following production condition.

Coil Production Condition
Constituent material of conductive wire: Cu
Conductive wire diameter: 0.5 mm
Winding number (when measuring magnetic permeability): 7 turns
Winding number (when measuring iron loss): 30 turns (primary side), 30 turns (secondary side)

### Sample Nos. 2 to 23

Powder cores were obtained in the same manner as in the case of Sample No. 1 except that as the composite particles, those shown in Tables 1 and 2 were used, and by using the obtained powder cores, choke coils were obtained. The coverage of the surface of each first particle with the second particles was from 70 to 85%.

### Sample No. 24

After the first particles and the second particles were stirred and mixed by a stirring mixer which performs only stirring, the obtained mixed powder, an epoxy resin (a binding material), and toluene (an organic solvent) were mixed, whereby a mixture was obtained. Thereafter, a process was performed in the same manner as in the case of Sample No. 1, a powder core was obtained, and by using the obtained powder core, a choke coil was obtained.

In Tables 1 and 2, among the soft magnetic powders of the respective sample numbers, those corresponding to embodiments of the invention are represented by “Example”, and those not corresponding to embodiments of the invention are represented by “Comparative Example”. In Tables 1 and 2, (c) indicates that the constituent material of each particle is a crystalline soft magnetic metallic material, and (a) indicates that the constituent material of each particle is an amorphous soft magnetic metallic material.

### Sample No. 25

A powder core was obtained in the same manner as in the case of Sample No. 5, except that the coverage of the surface of each first particle with the second particles was decreased to 55% in the composite particles by decreasing the addition amount of the second particles, and by using the obtained powder core, a choke coil was obtained.

### Sample No. 26

A powder core was obtained in the same manner as in the case of Sample No. 5, except that the coverage of the surface of each first particle with the second particles was decreased to 40% in the composite particles by decreasing the addition amount of the second particles, and by using the obtained powder core, a choke coil was obtained.

### Sample Nos. 27 and 28

Powder cores were obtained in the same manner as in the case of Sample Nos. 5 and 7, respectively, except that the binding agent was changed to a silicone resin, and by using the obtained powder cores, choke coils were obtained.

### Sample Nos. 29 and 30

Powder cores were obtained in the same manner as in the case of Sample Nos. 5 and 7, respectively, except that the binding agent was changed to a phenolic resin, and by using the obtained powder cores, choke coils were obtained.

### 2. Evaluation of Composite Particle, Powder Core, and Choke Coil

### 2.1 Measurement of Average Crystal Grain Size by X-Ray Diffractometry

The X-ray diffraction spectrum of the composite particle of each sample number was obtained by X-ray diffractometry. For example, in the X-ray diffraction spectrum of the composite particle of Sample No. 1, a diffraction peak derived from an Fe—Si-based alloy and a diffraction peak derived from an Fe—Ni-based alloy were contained.

Therefore, based on the shape (half width) of each diffraction peak, the average crystal grain size of the crystalline structure contained in the first particle and the average crystal grain size of the crystalline structure contained in the second particle were calculated. The calculation results are shown in Tables 1 and 2.

### 2.2 Measurement of Density of Powder Core

The density of the powder core of each sample number was measured. Then, based on a true specific gravity calculated from the composition of the composite particle of each sample number, the relative density of each powder core was calculated. The calculation results are shown in Tables 1 and 2.

### 2.3 Measurement of Magnetic Permeability of Choke Coil

The magnetic permeability μ′ and the iron loss (core loss Pcv) of the choke coil of each sample number were measured according to the following measurement condition. The measurement results are shown in Tables 1 and 2.

Measurement Condition
Measurement frequency (magnetic permeability): 10 kHz, 100 kHz, 1000 kHz
Measurement frequency (iron loss): 50 kHz, 100 kHz
Maximum magnetic flux density: 50 mT, 100 mT
Measurement device: AC Magnetic Property Measurement System (B-H analyzer SY8258, manufactured by Iwatsu Test Instruments Corporation)

TABLE 1

| | | | | No. 1 | No. 2 | No. 3 | No. 4 | No. 5 | No. 6 |
|---|---|---|---|---|---|---|---|---|---|
| | | | | Example | Example | Example | Example | Example | Example |
| First | Fe—6.5Si (c) | | Parts by mass | 10 | 20 | 30 | 40 | 50 | 60 |
| particle | Fe—Si—B (a) | | Parts by mass | | | | | | |
| | Fe—Si—Al (c) | | Parts by mass | | | | | | |
| | Fe—Si—B—C (a) | | Parts by mass | | | | | | |
| | Vickers hardness HV1 | | — | 376 | 381 | 362 | 411 | 378 | 425 |
| | Equivalent circle diameter d1 | | μm | 35 | 37 | 60 | 32 | 54 | 45 |
| | Average crystal grain size | | nm | 57 | 55 | 59 | 49 | 56 | 42 |
| Second | Fe—50Ni (c) | | Parts by mass | 90 | 80 | 70 | 60 | 50 | 40 |
| particle | Fe—0.5B (c) | | Parts by mass | | | | | | |
| | Fe—1Cr (c) | | Parts by mass | | | | | | |
| | Pure Fe (c) | | Parts by mass | | | | | | |
| | Vickers hardness HV2 | | — | 202 | 213 | 218 | 198 | 221 | 205 |
| | Equivalent circle diameter d2 | | μm | 10 | 12 | 14 | 10 | 18 | 10 |
| | Average crystal grain size | | nm | 90 | 88 | 85 | 95 | 78 | 91 |
| HV1-HV2 | | | — | 174 | 168 | 144 | 213 | 157 | 220 |
| d1/d2 | | | μm | 3.5 | 3.1 | 4.3 | 3.2 | 3.0 | 4.5 |
| Average crystal grain size in first particle/ | | | — | 0.63 | 0.63 | 0.69 | 0.52 | 0.72 | 0.46 |
| Average crystal grain size in second particle | | | | | | | | | |
| Binding agent | | | — | epoxy | epoxy | epoxy | epoxy | epoxy | epoxy |
| Evaluation | Relative density | | % | 88.8 | 88.2 | 87.6 | 87.0 | 86.3 | 85.7 |
| results | Magnetic | 10 kHz | — | 61.2 | 60.8 | 60.3 | 59.7 | 59.2 | 58.3 |
| | permeability μ′ | 100 kHz | — | — | — | — | 59.7 | 59.4 | 58.2 |
| | | 1000 kHz | — | — | — | — | 59.3 | 58.9 | 57.7 |
| | Iron loss | 50 kHz | kW/m³ | 251 | 255 | 258 | 264 | 263 | 278 |
| | Bm = 50 mT | 100 kHz | kW/m³ | — | — | — | 551 | 548 | 572 |
| | Iron loss | 50 kHz | kW/m³ | 1532 | 1542 | 1551 | 1561 | 1565 | 1598 |
| | Bm = 100 mT | 100 kHz | kW/m³ | — | — | — | 3257 | 3271 | 3355 |
| | | | | | | | | No. 11 | No. 12 |
| | | | | No. 7 | No. 8 | No. 9 | No. 10 | Comparative | Comparative |
| | | | | Example | Example | Example | Example | Example | Example |
| First | Fe—6.5Si (c) | | Parts by mass | 70 | 80 | 90 | 95 | 0 | 100 |
| particle | Fe—Si—B (a) | | Parts by mass | | | | | | |
| | Fe—Si—Al (c) | | Parts by mass | | | | | | |
| | Fe—Si—B—C (a) | | Parts by mass | | | | | | |
| | Vickers hardness HV1 | | — | 358 | 349 | 371 | 450 | — | 384 |
| | Equivalent circle diameter d1 | | μm | 46 | 36 | 32 | 31 | — | 33 |
| | Average crystal grain size | | nm | 60 | 62 | 57 | 37 | — | 56 |
| Second | Fe—50Ni (c) | | Parts by mass | 30 | 20 | 10 | 5 | 100 | 0 |
| particle | Fe—0.5B (c) | | Parts by mass | | | | | | |
| | Fe—1Cr (c) | | Parts by mass | | | | | | |
| | Pure Fe (c) | | Parts by mass | | | | | | |
| | Vickers hardness HV2 | | — | 178 | 184 | 230 | 246 | 210 | — |
| | Equivalent circle diameter d2 | | μm | 8 | 4 | 10 | 3 | 11 | — |
| | Average crystal grain size | | nm | 112 | 106 | 63 | 71 | 87 | — |
| HV1-HV2 | | | — | 180 | 165 | 141 | 204 | — | — |
| d1/d2 | | | μm | 5.8 | 9.0 | 3.2 | 10.3 | — | — |
| Average crystal grain size in first particle/ | | | — | 0.54 | 0.58 | 0.90 | 0.52 | — | — |
| Average crystal grain size in second particle | | | | | | | | | |
| Binding agent | | | — | epoxy | epoxy | epoxy | epoxy | — | epoxy |
| Evaluation | Relative density | | % | 85.0 | 84.0 | 82.3 | 81.8 | 80.2 | 78.4 |
| results | Magnetic | 10 kHz | — | 56.7 | 54.2 | 51.4 | 50.2 | 45.3 | 41.2 |
| | permeability μ′ | 100 kHz | — | 56.6 | 54.1 | 51.5 | — | — | — |
| | | 1000 kHz | — | 56.1 | 53.6 | 51.1 | — | — | — |
| | Iron loss | 50 kHz | kW/m³ | 267 | 273 | 280 | 283 | 258 | 425 |
| | Bm = 50 mT | 100 kHz | kW/m³ | 560 | 572 | 595 | — | — | — |
| | Iron loss | 50 kHz | kW/m³ | 1646 | 1615 | 1666 | 1678 | 1554 | 2351 |
| | Bm = 100 mT | 100 kHz | kW/m³ | 3470 | 3425 | 3551 | — | — | — |

TABLE 2

| | | | | | | No. 15 | No. 16 | | |
|---|---|---|---|---|---|---|---|---|---|
| | | | | No. 13 | No. 14 | Comparative | Comparative | No. 17 | No. 18 |
| | | | | Example | Example | Example | Example | Example | Example |
| First particle | Fe—6.5Si (c) | | Parts by mass | | | | | | |
| | Fe—Si—B (a) | | Parts by mass | 50 | 70 | 0 | 100 | | |
| | Fe—Si—Al (c) | | Parts by mass | | | | | 30 | 60 |
| | Fe—Si—B—C (a) | | Parts by mass | | | | | | |
| | Vickers hardness HV1 | | — | 805 | 812 | — | 708 | 480 | 425 |
| | Equivalent circle diameter d1 | | μm | 40 | 85 | — | 83 | 54 | 45 |
| | Average crystal grain size | | nm | 0 | 0 | — | 0 | 56 | 42 |
| Second | Fe—50Ni (c) | | Parts by mass | | | | | | |
| particle | Fe—0.5B (c) | | Parts by mass | 50 | 30 | 100 | 0 | | |
| | Fe—1Cr (c) | | Parts by mass | | | | | 70 | 40 |
| | Pure Fe (c) | | Parts by mass | | | | | | |
| | Vickers hardness HV2 | | — | 246 | 241 | 278 | — | 193 | 205 |
| | Equivalent circle diameter d2 | | μm | 10 | 15 | 15 | — | 5 | 10 |
| | Average crystal grain size | | nm | 90 | 74 | 85 | — | 78 | 72 |
| HV1-HV2 | | | — | 559 | 571 | — | — | 287 | 220 |
| d1/d2 | | | μm | 4.0 | 5.7 | — | — | 10.8 | 4.5 |
| Average crystal grain size in first particle/ | | | — | 0.00 | 0.00 | — | — | 0.72 | 0.58 |
| Average crystal grain size in second particle | | | | | | | | | |
| Binding agent | | | — | epoxy | epoxy | — | epoxy | epoxy | epoxy |
| Evaluation | Relative density | | % | 85.2 | 84.3 | 80.5 | 79.2 | 84.9 | 84.3 |
| results | Magnetic | 10 kHz | — | 67.5 | 68.2 | 54.2 | 58.2 | 59.2 | 58.3 |
| | permeability μ′ | 100 kHz | — | — | — | — | — | — | — |
| | | 1000 kHz | — | — | — | — | — | — | — |
| | Iron loss | 50 kHz | kW/m³ | 65 | 66 | 70 | 75 | 263 | 278 |
| | Bm = 50 mT | 100 kHz | kW/m³ | — | — | — | — | — | — |
| | Iron loss | 50 kHz | kW/m³ | 387 | 389 | 402 | 423 | 1565 | 1598 |
| | Bm = 100 mT | 100 kHz | kW/m³ | — | — | — | — | — | — |
| | | | | No. 19 | No. 20 | No. 21 | No. 22 | No. 23 | No. 24 |
| | | | | Comparative | Comparative | Comparative | Comparative | Comparative | Comparative |
| | | | | Example | Example | Example | Example | Example | Example |
| First particle | Fe—6.5Si (c) | | Parts by mass | | | | Fe—50Ni (c) | 50 | 50 |
| | Fe—Si—B (a) | | Parts by mass | | | | | | |
| | Fe—Si—Al (c) | | Parts by mass | 0 | 100 | | | | |
| | Fe—Si—B—C (a) | | Parts by mass | | | 50 | | | |
| | Vickers hardness HV1 | | — | — | 449 | 1321 | 210 | 348 | 370 |
| | Equivalent circle diameter d1 | | μm | — | 36 | 32 | 25 | 105 | 50 |
| | Average crystal grain size | | nm | — | 60 | — | — | — | 55 |
| Second | Fe—50Ni (c) | | Parts by mass | | | | | | 50 |
| particle | Fe—0.5B (c) | | Parts by mass | | | | | 50 | |
| | Fe—1Cr (c) | | Parts by mass | 100 | 0 | | | | |
| | Pure Fe (c) | | Parts by mass | | | 50 | 50 | | |
| | Vickers hardness HV2 | | — | 178 | — | 95 | 94 | 275 | 220 |
| | Equivalent circle diameter d2 | | μm | 12 | — | 15 | 21 | 1.5 | 16 |
| | Average crystal grain size | | nm | 81 | — | 185 | 203 | 36 | 42 |
| HV1-HV2 | | | — | — | — | 1226 | 116 | 73 | 150 |
| d1/d2 | | | μm | — | — | — | — | — | — |
| Average crystal grain size in first particle/ | | | — | — | — | 0.00 | 0.00 | 0.00 | 1.31 |
| Average crystal grain size in second particle | | | | | | | | | |
| Binding agent | | | — | — | epoxy | epoxy | epoxy | epoxy | epoxy |
| Evaluation | Relative density | | % | 81.2 | 80.4 | 68.2 | 81.3 | 72.8 | 65.4 |
| results | Magnetic | 10 kHz | — | 56.7 | 54.2 | 32.5 | 48.2 | 36.1 | 30.1 |
| | permeability μ′ | 100 kHz | — | — | — | — | — | — | — |
| | | 1000 kHz | — | — | — | — | — | — | — |
| | Iron loss | 50 kHz | kW/m³ | 298 | 301 | — | — | — | — |
| | Bm = 50 mT | 100 kHz | kW/m³ | — | — | — | — | — | — |
| | Iron loss | 50 kHz | kW/m³ | 1646 | 1615 | — | — | — | — |
| | Bm = 100 mT | 100 kHz | kW/m³ | — | — | — | — | — | — |

As apparent from Tables 1 and 2, the powder cores corresponding to Examples had a high relative density. Further, the magnetic permeability μ′ was in a positive correlation with the relative density, and the powder cores corresponding to Examples showed a relatively high magnetic permeability value. On the other hand, with respect to the iron loss of the choke coil, it was confirmed that the iron loss was low in a wide frequency range in a high frequency band.

Incidentally, the distribution state of the first particles and the second particles inside the powder core of Sample No. 24 was observed, and it was confirmed that there were regions where only the first particles aggregated locally or only the second particles aggregated locally.

The above-described composite particles of the respective sample numbers all had the configuration shown in FIG. 1, and therefore, similar samples having the configuration shown in FIG. 2 were also produced and the respective evaluations were performed. As a result, the evaluation results of the samples having the configuration shown in FIG. 2 showed the same tendency as that of the evaluation results of the above-described composite particles of the respective sample numbers.

Although not shown in the respective tables, the powder cores of Sample Nos. 25 and 26 had a lower relative density as compared with the powder cores corresponding to the respective Examples shown in Tables 1 and 2. It is considered that this is due to the effect of low coverage.

Further, although not shown in the respective tables, the powder cores of Sample Nos. 27 to 30 showed properties equivalent to those of the powder cores corresponding to the respective Examples shown in Tables 1 and 2.

The entire disclosure of Japanese Patent Application No. 2012-254452 filed Nov. 20, 2012 is incorporated by reference herein.

What is claimed is:

1. A composite particle, comprising:
a first particle composed of a soft magnetic metallic material; and
second particles composed of a soft magnetic metallic material having a different composition from that of the first particle and adhered to the first particle, wherein
when a Vickers hardness of the first particle is represented by HV1 and a Vickers hardness of the second particle is represented by HV2, HV1 and HV2 satisfy: 250≦HV1≦1200, 100≦HV2<250, and 100≦HV1−HV2, and
when a projected area circle equivalent diameter of the first particle is represented by d1 and a projected area circle equivalent diameter of each second particle is represented by d2, d1 and d2 satisfy: 30 μm≦d1≦100 μm and 2 μm≦d2≦20 μm.

2. The composite particle according to claim 1, wherein the second particles are adhered to the first particle so as to cover at least 70% of a surface of the first particle.

3. The composite particle according to claim 1, wherein the second particles are bound to the first particle via a binding agent.

4. The composite particle according to claim 3, wherein the binding agent contains at least one of a silicone resin, an epoxy resin, and a phenolic resin.

5. The composite particle according to claim 1, wherein
the soft magnetic metallic material constituting the first particle and the soft magnetic metallic material constituting the second particle are each a crystalline metallic material, and
an average crystal grain size in the first particle as measured by X-ray diffractometry is 0.2 times or more and 0.95 times or less than an average crystal grain size in the second particle as measured by X-ray diffractometry.

6. The composite particle according to claim 1, wherein the soft magnetic metallic material constituting the first particle is an amorphous metallic material or a nanocrystalline metallic material, and the soft magnetic metallic material constituting the second particle is a crystalline metallic material.

7. The composite particle according to claim 5, wherein the average crystal grain size in the second particle as measured by X-ray diffractometry is 30 μm or more and 200 μm or less.

8. The composite particle according to claim 1, wherein the soft magnetic metallic material constituting the first particle is an Fe—Si-based material.

9. The composite particle according to claim 8, wherein the soft magnetic metallic material constituting the second particle is any of pure Fe, an Fe—B-based material, an Fe—Cr-based material, and an Fe—Ni-based material.

10. The composite particle according to claim 1, wherein the composite particle is configured such that a mass ratio of the first particle to the second particle is 20:80≦the mass of the first particle:the mass of the second particle≦97:3.

11. A powder core, comprising:
a compressed powder body obtained by compression-molding composite particles each including a first particle composed of a soft magnetic metallic material and second particles composed of a soft magnetic metallic material having a different composition from that of the first particle and adhered to the first particle so as to cover the first particle and a binding material which binds the composite particles, wherein
when a Vickers hardness of the first particle is represented by HV1 and a Vickers hardness of the second particle is represented by HV2, HV1 and HV2 satisfy: 250≦HV1≦1200, 100≦HV2<250, and 100≦HV1−HV2,
when a projected area circle equivalent diameter of the first particle is represented by d1 and a projected area circle equivalent diameter of each second particle is represented by d2, d1 and d2 satisfy: 30 μm≦d1≦100 μm and 2 μm≦d2≦20 μm, and
the second particles are deformed along a surface of the first particle.

12. The powder core according to claim 11, wherein the second particles are bound to the first particle via a binding agent.

13. A magnetic element, comprising the powder core according to claim 11.

14. A magnetic element, comprising the powder core according to claim 12.

15. A portable electronic device, comprising the magnetic element according to claim 13.

16. A portable electronic device, comprising the magnetic element according to claim 14.

17. A composite particle, comprising:
a soft magnetic metallic first particle having:
a Vickers hardness HV1; and
a projected area circle equivalent diameter d1; and
soft magnetic metallic second particles adhered to the first particle, the second particles having:
a different composition from that of the first particle;
a Vickers hardness HV2a; and
a projected area circle equivalent diameter d2,
wherein 250≦HV1≦1200, 100≦HV2<250, and 100≦HV1−HV2, and
30 μm≦d1≦100 μm and 2 μm≦d2≦20 μm.
